(19) United States
(12) Patent Application Publication
(10) Pub. No.: US 2015/0201138 A1
(43) Pub. Date: Jul. 16, 2015

(54) SOLID-STATE IMAGING DEVICE AND CAMERA SYSTEM

(71) Applicant: Kabushiki Kaisha Toshiba, Minato-ku (JP)

(72) Inventors: Kazuhiro HIWADA, Yokohama (JP); Yukiyasu TATSUZAWA, Yokohama (JP); Tatsuji ASHITANI, Yokohama (JP)

(73) Assignee: Kabushiki Kaisha Toshiba, Minato-ku (JP)

(21) Appl. No.: 14/476,870

(22) Filed: Sep. 4, 2014

(30) Foreign Application Priority Data
Jan. 14, 2014 (JP) 2014-004414

(51) Int. Cl. H04N 5/345; H04N 9/04; H04N 5/376; H04N 5/355; H04N 3/14

(52) U.S. Cl. CPC H04N 5/3454; H04N 5/35581; H04N 3/1556; H04N 5/3765; H04N 9/045; H04N 2101/00

(57) ABSTRACT

According to one embodiment, a solid-state imaging device comprises a pixel array wherein unit patterns are placed repeatedly the unit pattern along vertical and horizontal directions. The unit pattern has at least four pixels arranged vertically and two pixels arranged horizontally. The unit pattern is formed of pixels of a first group including two first green pixels and pixels of a second group including two second green pixels. The two first green pixels are arranged vertically with one of a red pixel and a blue pixel in between, and the two second green pixels are arranged vertically with one of a red pixel and a blue pixel in between.

### CROSS-REFERENCE TO RELATED APPLICATIONS

This application is based upon and claims the benefit of priority from Japanese Patent Application No. 2014-004414, filed on Jan. 14, 2014; the entire contents of all of which are incorporated herein by reference.

### FIELD

Embodiments described herein relate generally to a solid-state imaging device and a camera system.

### BACKGROUND

High dynamic range (HDR) composition is known as an image capturing technique for expressing a wider dynamic range as compared with usual image capturing. As an HDR composition technique, for example, a technique which composes signals from pixels made different in the accumulation time of signal charge is known.

As a solid-state imaging device which implements this HDR composition, there is, for example, one in which pairs of two horizontal lines comprising long-time exposure pixels and pairs of two horizontal lines comprising short-time exposure pixels are alternately arranged along a vertical direction. In the case of a technique using this solid-state imaging device, the process of obtaining the signal of one pixel of an HDR composed image from the signals of a plurality of pixels adjacent to that pixel is carried out. With this technique, the resolution of HDR composed images is reduced in half in terms of the number of pixels of the image sensor.

As another solid-state imaging device which implements HDR composition, a technique has been proposed in which long-time exposure pixels and short-time exposure pixels are in a periodic arrangement along vertical and horizontal directions. Where control to make exposure times for pixels arranged along the horizontal direction different is performed, additional lines used to control the reading of signals from pixels may need to be provided. In this case, because of an increase in the number of lines, the image sensor of the solid-state imaging device becomes complicated in structure, and thus it becomes difficult to make the image sensor smaller. As to the solid-state imaging device, with each pixel of the image sensor being finer, it is more difficult to increase the number of lines.

Solid-state imaging devices that control the reading of signals from pixels may be applied, for example, to capturing high-speed moving images as well as HDR composition. As a solid-state imaging device for capturing high-speed moving images, there is, for example, one which thins out horizontal lines to read signals for each frame while switching horizontal lines to be excluded from reading alternately between frames. Also, in this case, the resolution of moving images is reduced to half of the resolution of the image sensor. Further, in order to make timings to read signals from pixels arranged horizontally different, additional lines used to control the reading of signals from pixels may need to be provided. In this case, the image sensor becomes complicated in structure, and also it becomes difficult to make the image sensor smaller.

### BRIEF DESCRIPTION OF THE DRAWINGS

FIG. 1 is a block diagram showing schematically the configuration of the solid-state imaging device according to the first embodiment;

FIG. 2 is a block diagram showing schematically the configuration of a camera system comprising the solid-state imaging device;

FIG. 3 is a diagram showing an example of the pixel color arrangement in a pixel array and the setting of exposure time for each pixel;

FIG. 4 is a diagram showing a unit pattern of color pixels of first and second groups included in the pixel array shown in FIG. 3;

FIG. 5 is a diagram showing signal lines to read signals from pixels;

FIG. 6 is a diagram showing an example where the signal in a G pixel is generated by interpolation;

FIG. 7 is a diagram showing an example where the signal in an R pixel is generated by interpolation;

FIG. 8 is a diagram showing an example where the signal in a B pixel is generated by interpolation;

FIG. 9 is a diagram showing an example of the pixel color arrangement in the pixel array and the control of reading a signal from each pixel;

FIG. 10 is a diagram for explaining a second frame reconstructing method by which an ISP reconstructs frames; and

FIG. 11 is a diagram for explaining a third frame reconstructing method by which the ISP reconstructs frames.

### DETAILED DESCRIPTION

In general, according to one embodiment, a solid-state imaging device comprises a pixel array, a control unit, and a signal processing unit. In the pixel array, first and second groups of pixels are Bayer arranged along a vertical direction and a horizontal direction. The first and second groups of pixels are multiple pixels accumulating signal charge generated according to the amount of incident light. The first group of pixels are exposed for a first time. The second group of pixels are exposed for a second time. The second time is shorter than the first time. The control unit controls reading signals from the first and second groups of pixels. The signal processing unit performs high dynamic range composition of signals from the first group of pixels and signals from the second group of pixels. In the pixel array, unit patterns are placed in a repeated pattern along vertical and horizontal directions. The unit pattern has at least four pixels arranged vertically and two pixels arranged horizontally. The unit pattern is formed of pixels of the first group including two first green pixels and pixels of the second group including two second green pixels. The two first green pixels are arranged vertically with one of a red pixel and a blue pixel in between. The two second green pixels are arranged vertically with one of a red pixel and a blue pixel in between.

Exemplary embodiments of a solid-state imaging devices and a camera system will be explained below in detail with reference to the accompanying drawings. The present invention is not limited to the following embodiments.

### First Embodiment

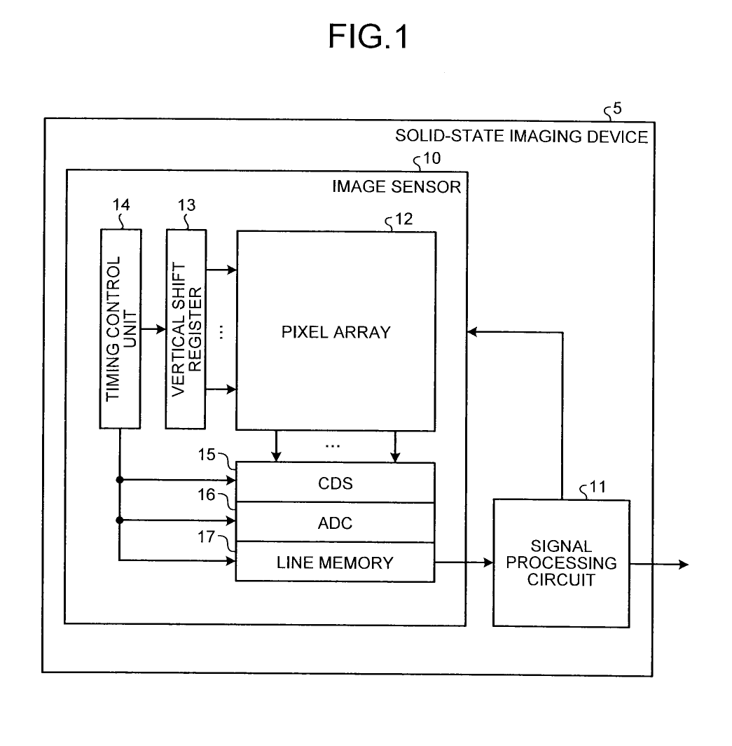

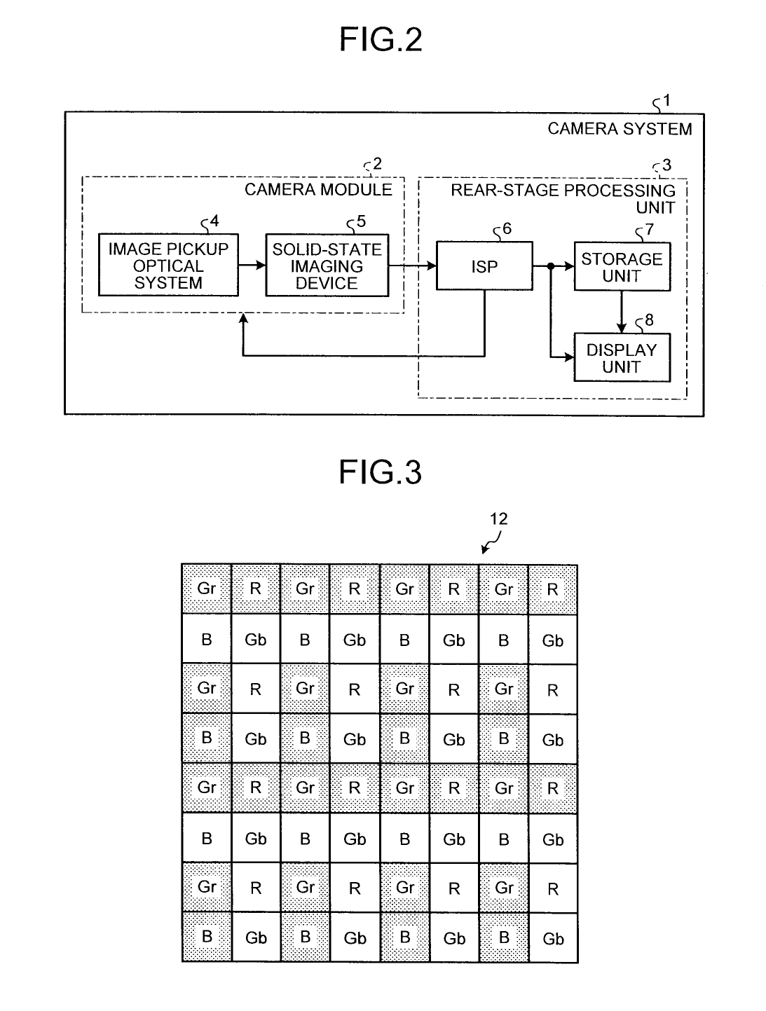

FIG. 1 is a block diagram showing schematically the configuration of the solid-state imaging device according to the first embodiment. FIG. 2 is a block diagram showing schematically the configuration of a camera system comprising the solid-state imaging device. The camera system 1 has a camera module 2 and a rear-stage processing unit 3. The camera system 1 is, for example, a digital camera. The digital camera may be either of a digital still camera and a digital video camera. The camera system 1 may be an electronic device comprising the camera module 2 (e.g., a mobile terminal with a camera) or the like other than a digital camera. The camera module 2 has an image pickup optical system 4 and the solid-state imaging device 5. The rear-stage processing unit 3 has an image signal processor (ISP) 6, a storage unit 7, and a display unit 8.

The image pickup optical system 4 takes in light from a subject to form a subject image. The solid-state imaging device 5 captures the subject image. The ISP 6 that is an image processing device performs signal processing on an image signal obtained through image capturing by the solid-state imaging device 5. The storage unit 7 stores images having undergone the signal processing in the ISP 6. The storage unit 7 outputs an image signal to the display unit 8 according to the operation by a user or the like.

The display unit 8 displays an image according to the image signal input from the ISP 6 or storage unit 7. The display unit 8 is, for example, a liquid crystal display. The camera system 1 performs feedback control of the camera module 2 based on data having undergone the signal processing in the ISP 6.

The solid-state imaging device 5 comprises an image sensor 10 that is an image pickup element and a signal processing circuit 11 that is a signal processing unit. The image sensor 10 is, for example, a CMOS image sensor. The image sensor 10 may be a CCD instead of the CMOS image sensor.

The image sensor 10 has a pixel array 12, a vertical shift register 13, a timing control unit 14, a correlated double sampling unit (CDS) 15, an analog-to-digital converter (ADC) 16, and a line memory 17.

The pixel array 12 is provided in the image pickup area of the image sensor 10. The pixel array 12 comprises multiple pixels arranged in an array along a horizontal direction (row direction) and a vertical direction (column direction). Each pixel comprises a photodiode that is a photoelectric conversion element. Each pixel generates an amount of signal charge according to the amount of incident light in exposure time and accumulates signal charge generated according to the amount of incident light.

The timing control unit 14 that is a control unit controls the reading of signals from multiple pixels. The timing control unit 14 supplies a vertical synchronizing signal to designate a timing at which to read a signal from each pixel of the pixel array 12 to the vertical shift register 13. Also, the timing control unit 14 supplies a timing signal to designate a drive timing to each of the CDS 15, ADC 16, and line memory 17.

The vertical shift register 13 selects pixels in the pixel array 12 on a per horizontal line basis according to the vertical synchronizing signal. The vertical shift register 13 outputs a read signal to the pixels of the selected horizontal line. The pixel having the read signal inputted thereto outputs accumulated signal charge. The pixel array 12 outputs the signals from the pixels via vertical signal lines to the CDS 15.

The CDS 15 performs a correlated double sampling process on the signals from the pixel array 12 to reduce fixed pattern noise. The ADC 16 converts a signal of analog form into a signal of digital form. The line memory 17 stores signals from the ADC 16. The image sensor 10 outputs signals stored in the line memory 17.

The signal processing circuit 11 that is a signal processing unit performs a variety of signal processing on the image signal from the image sensor 10. The signal processing circuit 11 performs high dynamic range composition of signals from a first group of pixels and signals from a second group of pixels. Also, the signal processing circuit 11 performs a variety of signal processing such as defect correction, gamma correction, a noise reduction process, lens shading correction, white balance adjustment, distortion correction, and resolution restoration.

The solid-state imaging device 5 outputs the image signal having undergone signal processing in the signal processing circuit 11 to the outside of the chip. The solid-state imaging device 5 performs feedback control of the image sensor 10 based on data having undergone signal processing in the signal processing circuit 11.

The camera system 1 may have the ISP 6 perform at least any of the variety of signal processing that the signal processing circuit 11 performs in the present embodiment. The camera system 1 may have both the signal processing circuit 11 and the ISP 6 perform at least any of the variety of signal processing. The signal processing circuit 11 and the ISP 6 may perform other signal processing than the signal processing described in the present embodiment.

FIG. 3 is a diagram showing an example of the pixel color arrangement in the pixel array 12 and the setting of exposure time for each pixel. In the pixel array 12, the arrangement of color pixels along a vertical direction and a horizontal direction is a Bayer arrangement.

The Bayer arrangement is formed of units of a 2×2 pixel block. In this pixel block, a red (R) pixel and a blue (B) pixel are placed along a diagonal, and two green (G) pixels are placed along the other diagonal. The G pixel horizontally adjacent to the B pixel from among the two G pixels included in the pixel block is called a Gb pixel (first green pixel). The G pixel horizontally adjacent to the R pixel from among the two G pixels included in the pixel block is called a Gr pixel (second green pixel). In the pixel array 12, R pixels and Gr pixels are alternately, horizontally arranged, and also B pixels and Gb pixels are likewise arranged.

The multiple pixels arranged in the pixel array 12 are divided into a first group and a second group. The first group of pixels are exposed for a long time, and let a first time be the exposure time. The second group of pixels are exposed for a short time, and let a second time be the exposure time. That is, the second time is shorter than the first time.

In the pixel array 12 shown in FIG. 3, let the hollow pixels form the first group and the shaded pixels form the second group. The first group includes R, B, Gb pixels. The second group includes R, B, Gr pixels.

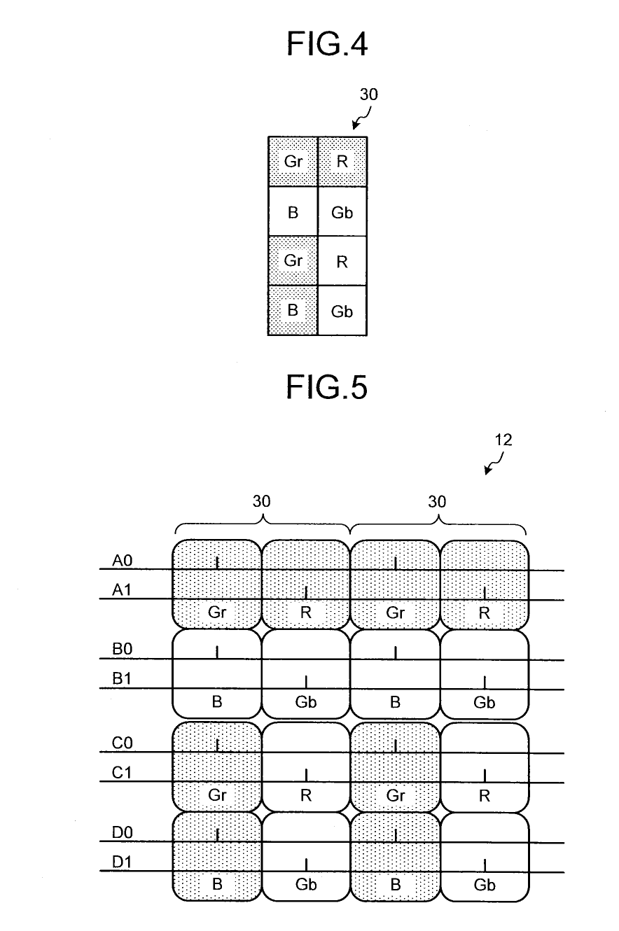

FIG. 4 is a diagram showing a unit pattern of color pixels of the first and second groups included in the pixel array shown in FIG. 3. The unit pattern 30 consists of eight pixels, of which four pixels are arranged vertically and two pixels are arranged horizontally. In the pixel array 12, unit patterns 30 are placed in a repeated pattern along vertical and horizontal directions.

The unit pattern 30 includes one of each of R and B pixels and two Gb pixels as pixels of the first group. The R pixel of the first group is sandwiched vertically between the two Gb pixels. The B pixel of the first group is horizontally adjacent to a Gb pixel. Further, the unit pattern 30 includes one of each of R and B pixels and two Gr pixels as pixels of the second group. The R pixel of the second group is horizontally adjacent to a Gr pixel. The B pixel of the second group is vertically adjacent to the other Gr pixel.

The unit pattern 30 includes two Gb pixels arranged vertically with an R pixel in between and two Gr pixels arranged vertically with a B pixel in between. Because such unit patterns 30 are arranged horizontally, the pixel array 12 includes horizontal lines where pixels of the first group are arranged horizontally and horizontal lines where pixels of the second group are arranged horizontally. Further, the pixel array 12 shown in FIG. 3 includes horizontal lines where B and Gb pixels of the first group are alternately arranged and horizontal lines where Gr and R pixels of the second group are alternately arranged. Horizontal lines formed of pixels of the first group and horizontal lines formed of pixels of the second group are arranged periodically along a vertical direction.

FIG. 5 is a diagram showing signal lines to read signals from pixels. The pixels of the pixel array 12 have MOS transistors that are constituents of pixels in common on a per 2×2 pixel basis. The 2×2 pixel corresponds to the pixel block as a unit of the Bayer arrangement. This structure is hereinafter called a 2V2H pixel sharing structure. The four adjacent pixels have, e.g., a transfer transistor, a reset transistor, an amplification transistor, and a row select transistor in common, which are MOS transistors. Since being of the pixel sharing structure, the image sensor 10 has a reduced pixel pitch as compared with the case where MOS transistors are placed for each pixel. The pixel sharing structure is suitable to make the image sensor 10 smaller.

In the image sensor 10, two signal lines are placed in each horizontal line in order to control driving pixels according to color arrangement. Eight signal lines A0, A1, B0, B1, C0, C1, D0, D1 are connected to the unit pattern 30. The timing control unit 14 controls reset and reading of signal charge for each of the signal lines. By this means, the image sensor 10 can realize control of driving pixels according to setting of exposure time for each pixel and color arrangement.

The signal lines A0, A1 are provided for a horizontal line where Gr and R pixels of the second group are alternately arranged. The signal line A0 is connected to the Gr pixels of this horizontal line. The signal line A1 is connected to the R pixels of this horizontal line. The signal lines B0, B1 are provided for a horizontal line where B and Gb pixels of the first group are alternately arranged. The signal line B0 is connected to the B pixels of this horizontal line. The signal line B1 is connected to the Gb pixels of this horizontal line.

The signal lines C0, C1 are provided for a horizontal line where Gr pixels of the second group and R pixels of the first group are alternately arranged. The signal line C0 is connected to the Gr pixels of this horizontal line. The signal line C1 is connected to the R pixels of this horizontal line. The signal lines D0, D1 are provided for a horizontal line where B pixels of the second group and Gb pixels of the first group are alternately arranged. The signal line D0 is connected to the B pixels of this horizontal line. The signal line D1 is connected to the Gb pixels of this horizontal line.

The timing control unit 14 adjusts a time from reset of signal charge to reading of accumulated signal charge to be at the first time for the signal lines B0, B1, C1, D1. The timing control unit 14 adjusts a time from reset of signal charge to reading of accumulated signal charge to be at the second time for the signal lines A0, A1, C0, D0. By this means, the timing control unit 14, setting exposure time at the first time for the first group and at the second time for the second group, controls reading of signals from the pixels.

As to each pixel of the image sensor 10, when the amount of incident light exceeds a predetermined saturation light amount, signal charge generated by photoelectric conversion reaches the accumulation capacity of the photodiode. The signal processing circuit 11, for pixels of the first group of which the amount of incident light has reached the saturation light amount, interpolates from signals generated in pixels of the second group located in the vicinity of them. The signal processing circuit 11 performs this interpolation as HDR composition. By this means, the solid-state imaging device 5 obtains an image having a wider dynamic range as compared with usual image capturing.

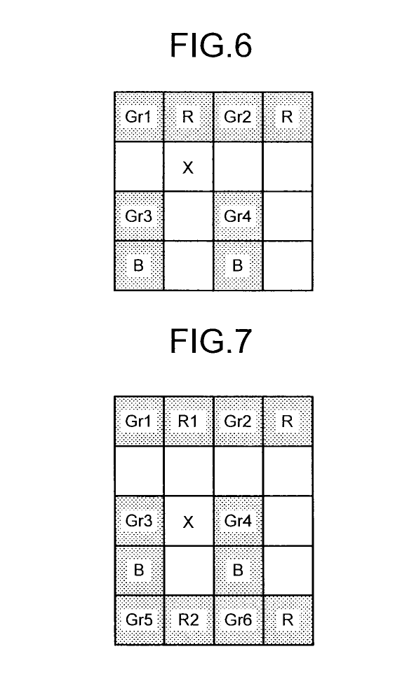

FIGS. 6 to 8 show examples of the interpolation with a pixel of the first group as a subject pixel. Note that the interpolation described in the present embodiment presents an example and may be changed as needed. FIG. 6 is a diagram showing an example where the signal in a G pixel is generated by interpolation. In this example, the subject pixel X is supposed to be a Gb pixel of the first group. The signal processing circuit 11 calculates an interpolated value based on signals from four Gr pixels (Gr1, Gr2, Gr3, Gr4) located in the vicinity of the subject pixel X. Gr1 to Gr4 are each diagonally adjacent to the subject pixel X.

In order to make the output levels of pixels of the first group and pixels of the second group coincide, the signal processing circuit 11 multiplies the signals from the pixels of the second group by a predetermined gain. The gain is equal to, e.g., the ratio of the first time to the second time.

The signal processing circuit 11 takes the value obtained by multiplying, e.g., the average of the signal levels of Gr1 to Gr4 by the gain as an interpolated value for the subject pixel X. The signal processing circuit 11 restores image data of the subject pixel X that was not taken in because of output saturation by this interpolation. Where the subject pixel X is a Gr pixel of the first group, the signal processing circuit 11 calculates an interpolated value from the signal levels of Gb pixels located in the vicinity thereof.

FIG. 7 is a diagram showing an example where the signal in an R pixel is generated by interpolation. The subject pixel X is an R pixel of the first group. R1, R2 are R pixels of the second group vertically adjacent to the subject pixel X with a pixel in between.

The signal processing circuit 11 refers to the signal levels of R1, R2 and the signal levels of six Gr pixels (Gr1, Gr2, Gr3, Gr4, Gr5, Gr6). Gr1, Gr2 are Gr pixels located on opposite sides of R1 along a horizontal direction. Gr3, Gr4 are Gr pixels located on opposite sides of the subject pixel X along a horizontal direction. Gr5, Gr6 are Gr pixels located on opposite sides of R2 along a horizontal direction.

The signal processing circuit 11 obtains the average value AA of signal levels based on, e.g., the following equations (1), (2), (3). In the equations, for example, the signal level of R1 is denoted by [R1].

ΔGR1=([Gr1]+[Gr2])/2−[R1] (1)

ΔGR2=([Gr5]+[Gr6])/2−[R2] (2)

AA=([Gr3]+[Gr4])/2−(ΔGR1+ΔGR2)/2 (3)

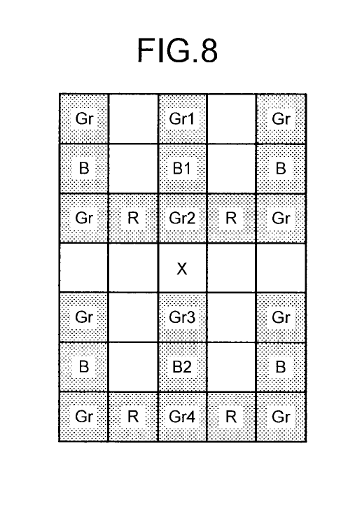

FIG. 8 is a diagram showing an example where the signal in a B pixel is generated by interpolation. The subject pixel X is a B pixel of the first group. B1, B2 are B pixels of the second group vertically adjacent to the subject pixel X with a pixel in between. Gr1, Gr2, Gr3, Gr4 are Gr pixels between adjacent ones of which a B pixel (B1, X, B2) is sandwiched along a vertical direction.

The signal processing circuit 11 obtains the average value AB of signal levels based on, e.g., the following equations (4), (5), (6).

ΔGB1=([Gr1]+[Gr2])/2−[B1] (4)

ΔGB2=([Gr3]+[Gr4])/2−[B2] (5)

AB=([Gr2]+[Gr3])/2−(ΔGB1+ΔGB2)/2 (6)

The signal processing circuit 11 takes the value obtained by, e.g., multiplying the average value by the gain as an interpolated value for the subject pixel X. The signal processing circuit 11 restores image data of the subject pixel X that was not taken in because of output saturation by this interpolation.

If a pixel at any position in the vicinity of the subject pixel X is a pixel of the second group, the signal processing circuit 11 may perform interpolation based on the signal of this pixel. The signal processing circuit 11 may change the number of pixels whose signal level it refers to as needed.

According to the present embodiment, the solid-state imaging device 5 adopts the unit pattern 30 where two pixels are arranged horizontally, thus having the configuration where two signal lines are placed in each horizontal line. With the 2V2H pixel sharing structure, the solid-state imaging device 5 can control driving pixels according to the setting of exposure time for each pixel and color arrangement without adding a signal line to each horizontal line. The solid-state imaging device 5 does not need provision of additional signal lines, and thus the structure of the image sensor 10 is simple and suitable to make the image sensor smaller.

The solid-state imaging device 5 has two G pixels of the first group arranged vertically and two G pixels of the second group arranged vertically in the unit pattern 30. With this arrangement, in the pixel array 12, G pixels of the first group are arranged with a pixel in between both vertically and horizontally. In the pixel array 12, G pixels of the second group are arranged with a pixel in between both vertically and horizontally.

It is known that the spectral sensitivity of human eyes has a peak in the wavelength range of G light. The resolution for the G component greatly affects the superficial resolution of color images as compared with those for the other color components. If intervals between G pixels of the first group or intervals between G pixels of the second group in the pixel array 12 were uneven, cases might occur where the signal levels of G pixels near or far from the subject pixel are used in the interpolation. As to the solid-state imaging device 5, if the signal levels of G pixels far from the subject pixel are used in the interpolation, the resolution for the G component is reduced, and thus it becomes difficult to maintain the superficial resolution of color images.

According to the present embodiment, because intervals between G pixels of the first group and intervals between G pixels of the second group are even, the solid-state imaging device 5 can easily maintain the superficial resolution of color images. As such, with the solid-state imaging device 5, the structure of the image sensor 10 can be made simple and suitable to make the image sensor smaller, and HDR composed images for which reduction in resolution is suppressed can be obtained.

Note that the arrangement of color pixels of the first and second groups in the unit pattern 30 may be changed as needed. For example, in the pixel array 12 shown in FIG. 3, eight different patterns of four pixels arranged vertically and two pixels arranged horizontally are included as patterns of groups and color arrangement. In the pixel array 12 shown in FIG. 3, the unit pattern 30 may be any of the eight different patterns. The unit pattern 30 may be a horizontally flipped pattern or a vertically inverted pattern of one of these patterns.

The unit pattern 30 may have the pixels shown as ones of the first group in FIGS. 3 and 4 changed into pixels of the second group and the pixels shown as ones of the second group changed into pixels of the first group. In this case, the Gr pixels included in the pixel array 12 are first green pixels of the first group. The Gb pixels included in the pixel array 12 are second green pixels of the second group.

The number of pixels arranged vertically in the unit pattern 30 is not limited to four. The number of pixels arranged vertically in the unit pattern 30 may be four or greater. The number of pixels arranged vertically may be a multiple of four, for example, eight. With the solid-state imaging device 5, also when the arrangement of the first and second groups of color pixel in the unit pattern 30 or the number of pixels arranged vertically in the unit pattern 30 is changed as needed, the effect that the structure of the image sensor 10 is simple and suitable to make the image sensor smaller and that reduction in resolution is suppressed can be obtained.

### Second Embodiment

The solid-state imaging device according to the second embodiment captures high-speed moving images by controlling reading signals from pixels. The solid-state imaging device according to the present embodiment has a configuration schematically the same as that shown in FIG. 1. The same reference numerals are used to denote the same parts as in the first embodiment, and duplicate description is omitted.

The timing control unit 14, for a first frame, reads signals from the first group of pixels from among the multiple pixels while stopping reading signals from the second group of pixels. The timing control unit 14, for a second frame subsequent to the first frame, reads signals from the second group of pixels while stopping reading signals from the first group of pixels. In this way, the timing control unit 14 controls the reading of signals from multiple pixels.

The signal processing circuit 11 performs signal processing on the image signal from the image sensor 10. The solid-state imaging device 5 outputs the image signal having undergone signal processing in the signal processing circuit 11 to the outside of the chip. The solid-state imaging device 5 changes the group of pixels to read signals from and the group of pixels to stop reading signals from between frames. The solid-state imaging device 5 can read signals for each frame at high speed by thinning out pixels to read signals from for each frame.

The ISP 6 (see FIG. 2) that is an image processing device performs processing on an image signal consisting of signals read from the multiple pixels. The ISP 6 performs signal processing sequentially on signals read for the first frame and signals read for the second frame.

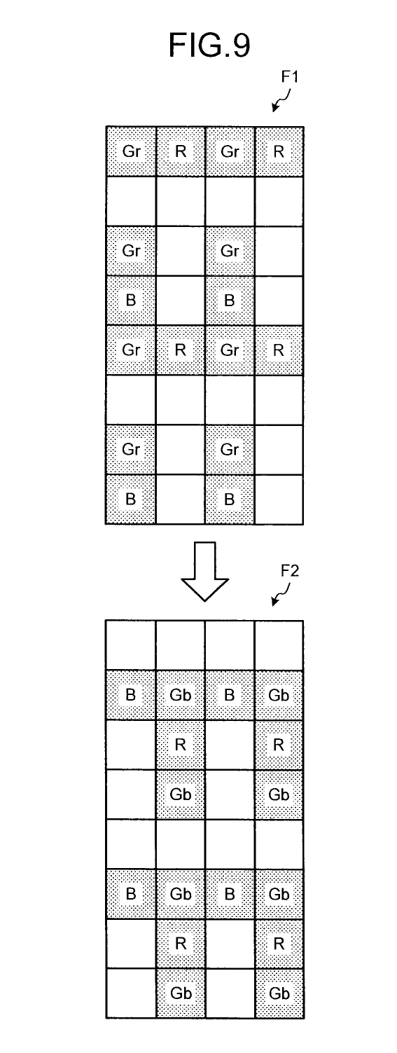

FIG. 9 is a diagram showing an example of the pixel color arrangement in the pixel array and the control of reading a signal from each pixel. In the pixel array 12, the arrangement of color pixels along a vertical direction and a horizontal direction is a Bayer arrangement.

The multiple pixels arranged in the pixel array 12 are divided into a first group and a second group. The upper part of FIG. 9 shows the pixel array 12 for the first frame F1. In the first frame F1, let the shaded pixels form the first group and the hollow pixels form the second group. The lower part of FIG. 9 shows the pixel array 12 for the second frame F2. In the second frame F2, let the shaded pixels form the second group and the hollow pixels form the first group.

For both the first frame F1 and the second frame F2, the signals of the shaded pixels are read, and the reading of the signals of the hollow pixels is stopped. As to the first group of pixels, signals are read from them for the first frame F1, and reading signals from them is stopped for the second frame F2. As to the second group of pixels, signals are read from them for the second frame F2, and reading signals from them is stopped for the first frame F1.

The timing control unit 14 repeats alternately control for the first frame F1 to read the signals of the first group of pixels and control for the second frame F2 to read the signals of the second group of pixels. The solid-state imaging device 5 reads signals from half of all the pixels included in the pixel array 12 for each frame. The solid-state imaging device 5 can double the speed of signal reading for each frame as compared with the case of reading signals of all the pixels for each frame.

In the pixel array 12 shown in FIG. 9, the first group includes R, B, Gr pixels. The second group includes R, B, Gb pixels. The Gr pixels (first green pixels) are all in the first group, and the Gb pixels (second green pixels) are all in the second group.

The pixel array 12 shown in FIG. 9 includes horizontal lines where Gr and R pixels of the first group are alternately arranged and horizontal lines where B and Gb pixels of the second group are alternately arranged. Horizontal lines formed of pixels of the first group and horizontal lines formed of pixels of the second group are arranged periodically along a vertical direction.

In the pixel array 12 of the second embodiment, as in the first embodiment, the pixels have MOS transistors that are constituents of pixels in common on a per 2×2 pixel basis, and the pixel array 12 has a 2V2H pixel sharing structure. In the image sensor 10, two signal lines are placed in each horizontal line. Eight signal lines A0 to D1 are connected to the unit pattern 30 as in FIG. 5. The timing control unit 14 controls reset and reading of signal charge for each of the signal lines.

The timing control unit 14, for the first frame F1, instructs the signal lines A0, A1, C0, D0 to read signal charge with leaving out the signal lines B0, B1, C1, D1. The timing control unit 14, for the second frame F2, instructs the signal lines B0, B1, C1, D1 to read signal charge with leaving out the signal lines A0, A1, C0, D0 conversely to the first frame F1. In the present embodiment, a time from reset of signal charge to reading of accumulated signal charge are the same for both the first frame F1 and the second frame F2.

According to the present embodiment, the solid-state imaging device 5 adopts the unit pattern 30 where two pixels are arranged horizontally, thus having the configuration where two signal lines are placed in each horizontal line. With the 2V2H pixel sharing structure, the solid-state imaging device 5 can control driving pixels according to the setting of reading a signal from each pixel and color arrangement without adding a signal line to each horizontal line. With the 2V2H pixel sharing structure, the solid-state imaging device 5 does not need provision of additional signal lines, and thus the structure of the image sensor 10 is simple and suitable to make the image sensor smaller.

According to the present embodiment, because intervals between G pixels of the first group and intervals between G pixels of the second group are even, the solid-state imaging device 5 can easily maintain the superficial resolution of color images. As such, with the solid-state imaging device 5, the structure of the image sensor 10 can be made simple and suitable to make the image sensor smaller, and high-speed moving images for which reduction in resolution is suppressed can be obtained.

For example, the ISP 6 may perform interpolation with pixels from which signal charge has not been read as subject pixels. The ISP 6, for example, reconstructs image data of one frame based on information of the image signal obtained for that frame, which is a first frame reconstructing method.

The ISP 6, for the image signal of the first frame F1, interpolates from the signals of the first group of pixels to generate signals at the positions of the second group of pixels. The ISP 6, for the image signal of the second frame F2, interpolates from the signals of the second group of pixels to generate signals at the positions of the first group of pixels. By this means, the ISP 6 reconstructs image data of one frame based on information of the image signal obtained for that frame.

Also in the present embodiment, the interpolation process described in the first embodiment may be changed as needed. The ISP 6 performs, e.g., the same interpolation process as in the first embodiment. The ISP 6 restores image data of pixels from which signal charge has not been read by this interpolation.

The camera system 1 can maintain the resolution of the image sensor 10 without reducing it in half, by restoring image data by interpolation in the ISP 6. Thus, the camera system 1 can obtain high-speed, high-resolution moving images.

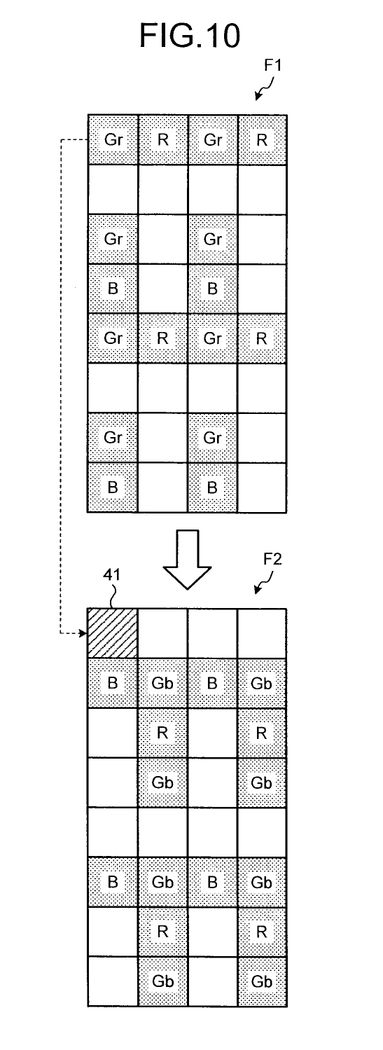

FIG. 10 is a diagram for explaining a second frame reconstructing method by which the ISP 6 reconstructs frames. The ISP 6, for example, reconstructs image data of one frame based on information of the image signal obtained for two or more frames, which is the second frame reconstructing method.

The ISP 6, for pixels from which signal charge has not been read in a frame, makes up for image data of those pixels using the image signal of the frame preceding or following that frame. FIG. 10 shows as an example the process of, for a pixel from which signal charge has not been read in the second frame F2, making up for image data thereof from the image signal of the first frame F1.

For the second frame F2, reading signal charge of Gr pixels of the first group is stopped. For the first frame F1, signal charge of the Gr pixels is read. For example, for position 41 of a Gr pixel, whose image data is missing, in the second frame F2, the ISP 6 acquires image data of the Gr pixel corresponding to the position 41 from the image signal of the first frame F1. The ISP 6 supplements the acquired image data as image data at position 41 to the image signal of the second frame F2.

The ISP 6, for example, for pixels from which signal charge has not been read in the first frame F1, may make up for image data thereof from the image signal of the second frame F2. The ISP 6, for example, for pixels from which signal charge has not been read in the second frame F2, may make up for image data thereof with the average of a signal level in the image signal of the first frame F1 and a signal level in the image signal of a third frame F3 subsequent to the second frame F2.

The ISP 6 makes up for the signal of each pixel of the second group from which signal charge has not been read in the first frame F1 with the signal of a pixel of the second group at the same position in the frame preceding the first frame F1, the signal of a pixel of the second group at the same position in the second frame F2, or the average of those signals.

The ISP 6 makes up for the signal of each pixel of the first group from which signal charge has not been read in the second frame F2 with the signal of a pixel of the first group at the same position in the first frame F1, the signal of a pixel of the first group at the same position in the frame subsequent to the second frame F2, or the average of those signals.

In this way, the ISP 6 reconstructs a frame based on information of the image signals in two or more frames. Also in this case, the camera system 1 can maintain the resolution of the image sensor 10 without reducing it in half, by restoring image data of pixels from which signal charge has not been read based on the image signals of the preceding and following frames by the ISP 6. Thus, the camera system 1 can obtain high-speed, high-resolution moving images.

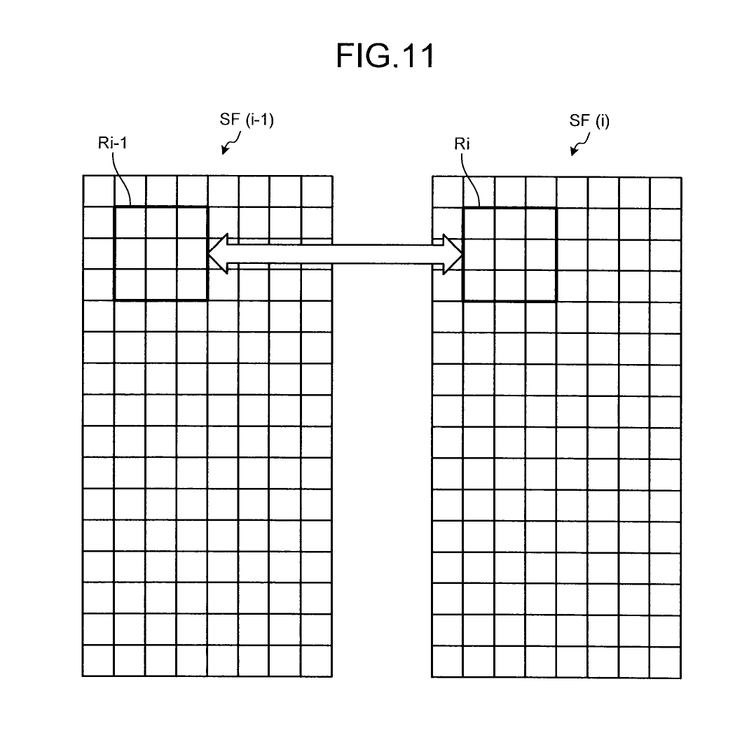

FIG. 11 is a diagram for explaining a third frame reconstructing method by which the ISP 6 reconstructs frames. The ISP 6 reconstructs, for example, a frame SF(i) and a frame SF(i−1) preceding the frame SF(i) by the above first frame reconstructing method. The frame SF(i−1) and frame SF(i) are first and second frames. The ISP 6 compares the result of reconstructing the frame SF(i) and the result of reconstructing the frame SF(i−1).

The ISP 6 extracts the signals of a pixel area Ri−1 (e.g., a 3×3 pixel area) from the frame SF(i−1). Further, the ISP 6 extracts the signals of the pixel area Ri at the same position as the pixel area Ri−1 from the frame SF(i). The ISP 6 obtains the sum of the absolute values of the differences in luminance value between the pixels of the pixel area Ri−1 and those of the pixel area Ri (Sum of Absolute Differences; SAD). The SAD value being larger indicates the movement of the subject being larger between the frame SF(i−1) and frame SF(i). The SAD value being smaller indicates the movement of the subject being smaller between the frame SF(i−1) and frame SF(i). The ISP 6 estimates the degree of movement of the subject by obtaining the SAD.

The ISP 6 obtains a first reconstructing result and a second reconstructing result for the frame SF(i). The first reconstructing result is the result of obtaining image data by the first frame reconstructing method. The second reconstructing result is the result of obtaining image data by the second frame reconstructing method.

The first frame reconstructing method reconstructs from information acquired of one frame, image data of the frame. The first frame reconstructing method is suitable for the case where with large movement of the subject, a reduction in artifacts (disturbances in images) is desired. The second frame reconstructing method reconstructs a frame using the signals of pixels at the same position of two or more frames. The second frame reconstructing method is suitable for the case where with small movement of the subject, an increase in resolution is desired.

For example, when the SAD is larger than a first threshold, the ISP 6 adopts the first reconstructing result as a reconstructing result for the frame SF(i). Thus, in the situation where with movement of the subject being large, a motion blur of the subject is likely to occur, artifacts are reduced. In the case of the first frame reconstructing method, because the average of the signals of multiple pixels is taken as the signal of a pixel, a reduction in resolution is likely to occur. As to this, the occurrence of a motion blur can make a reduction in resolution inconspicuous.

For example, when the SAD is smaller than a second threshold, the ISP 6 adopts the second reconstructing result as a reconstructing result for the frame SF(i). Thus, in the situation where with movement of the subject being small, motion blur is less, high resolution is realized.

For example, when the SAD is smaller than or equal to the first threshold and greater than or equal to the second threshold, the ISP 6 obtains a third reconstructing result. The third reconstructing result is one obtained by mixing the first reconstructing result and the second reconstructing result. When obtaining the third reconstructing result, the ISP 6 adjusts the proportion of the first reconstructing result to be mixed and the proportion of the second reconstructing result to be mixed according to the result of calculating the SAD.

At this time, the ISP 6 makes the proportion of the first reconstructing result to be mixed larger when the value of the SAD is larger. Thus, frames can be reconstructed such that the less the movement of the subject is, the greater importance is attached to the resolution and that on the other hand, the larger the movement of the subject is, the greater importance is attached to reduction in artifacts. As such, the ISP 6 outputs one of the first to third reconstructing results according to the value of the SAD.

The solid-state imaging device 5 can perform both the HDR composition of the first embodiment and high-speed moving images of the second embodiment using the pixel arrangement configuration common to them. The camera system 1 may be able to perform both the HDR composition of the first embodiment and high-speed moving images of the second embodiment. In this case, the timing control unit 14 may be able to switch reading signals from the multiple pixels between control for the HDR composition and control for capturing high-speed moving images.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array wherein a first group of pixels which are exposed for a first time and a second group of pixels which are exposed for a second time shorter than the first time are Bayer arranged along a vertical direction and a horizontal direction, the pixels accumulating signal charge generated according to the amount of incident light;
a control unit that controls reading signals from the first and second groups of pixels; and
a signal processing unit that performs high dynamic range composition of signals from the first group of pixels and signals from the second group of pixels,
wherein in the pixel array, unit patterns, in each of which at least four pixels are arranged vertically and two pixels are arranged horizontally, are placed repeatedly the unit pattern along vertical and horizontal directions, and
wherein the unit pattern is formed of pixels of the first group including two first green pixels arranged vertically with one of a red pixel and a blue pixel in between and pixels of the second group including two second green pixels arranged vertically with one of a red pixel and a blue pixel in between.

2. The solid-state imaging device according to claim 1, wherein the first green pixels are arranged horizontally alternating with blue pixels, and the second green pixels are arranged horizontally alternating with red pixels.

3. The solid-state imaging device according to claim 1, wherein the pixel array includes horizontal lines where pixels of the first group are arranged along the horizontal direction and horizontal lines where pixels of the second group are arranged along the horizontal direction.

4. The solid-state imaging device according to claim 1, wherein the unit pattern has four pixels arranged along the vertical direction and two pixels arranged along the horizontal direction.

5. The solid-state imaging device according to claim 1, wherein in the pixel array, two signal lines are placed for each horizontal line, where pixels are arranged along the horizontal direction, and
wherein the control unit controls reading signals for each signal line.

6. The solid-state imaging device according to claim 1, wherein the signal processing unit interpolates with a pixel of the first group as a subject pixel based on signal levels of pixels of the second group.

7. A solid-state imaging device comprising:
a pixel array wherein a first group of pixels and a second group of pixels, which accumulate signal charge generated according to the amount of incident light, are Bayer arranged along a vertical direction and a horizontal direction; and
a control unit that controls reading signals from the first and second groups of pixels in such a way as to, for a first frame, read signals from the first group of pixels with stopping reading signals from the second group of pixels and, for a second frame subsequent to the first frame, read signals from the second group of pixels with stopping reading signals from the first group of pixels,
wherein in the pixel array, unit patterns, in each of which at least four pixels are arranged vertically and two pixels are arranged horizontally, are placed repeatedly the unit pattern along vertical and horizontal directions, and
wherein the unit pattern is formed of pixels of the first group including two first green pixels arranged vertically with one of a red pixel and a blue pixel in between and pixels of the second group including two second green pixels arranged vertically with one of a red pixel and a blue pixel in between.

8. The solid-state imaging device according to claim 7, wherein the first green pixels are arranged horizontally alternating with blue pixels, and the second green pixels are arranged horizontally alternating with red pixels.

9. The solid-state imaging device according to claim 7, wherein the pixel array includes horizontal lines where pixels of the first group are arranged along the horizontal direction and horizontal lines where pixels of the second group are arranged along the horizontal direction.

10. The solid-state imaging device according to claim 7, wherein the unit pattern has four pixels arranged along the vertical direction and two pixels arranged along the horizontal direction.

11. The solid-state imaging device according to claim 7, wherein in the pixel array, two signal lines are placed for each horizontal line, where pixels are arranged along the horizontal direction, and
wherein the control unit controls reading signals for each signal line.

12. A camera system comprising:
an image pickup optical system that takes in light from a subject to form a subject image;
a pixel array wherein a first group of pixels and a second group of pixels, which accumulate signal charge generated according to the amount of incident light from the image pickup optical system, are Bayer arranged along a vertical direction and a horizontal direction; and
a control unit that controls reading signals from the first and second groups of pixels in such a way as to, for a first frame, read signals from the first group of pixels with stopping reading signals from the second group of pixels and, for a second frame subsequent to the first frame, read signals from the second group of pixels with stopping reading signals from the first group of pixels,
wherein in the pixel array, unit patterns, in each of which at least four pixels are arranged vertically and two pixels are arranged horizontally, are placed repeatedly the unit pattern along vertical and horizontal directions, and
wherein the unit pattern is formed of pixels of the first group including two first green pixels arranged vertically with one of a red pixel and a blue pixel in between and pixels of the second group including two second green pixels arranged vertically with one of a red pixel and a blue pixel in between.

13. The camera system according to claim 12, comprising:
an image processing device that performs signal processing on signals read for the first frame and signals read for the second frame,
wherein the image processing device interpolates from signals of pixels of the first group read for the first frame to generate signals at positions of pixels of the second group and interpolates from signals of pixels of the second group read for the second frame to generate signals at positions of pixels of the first group.

14. The camera system according to claim 12, comprising:
an image processing device that performs signal processing on signals read for the first frame and signals read for the second frame,
wherein the image processing device makes up for the signal at the position of each pixel of the second group in the first frame with the signal of a pixel of the second group at that position in a frame preceding the first frame or the signal of a pixel of the second group at that position in the second frame, and makes up for the signal at the position of each pixel of the first group in the second frame with the signal of a pixel of the first group at that position in the first frame or the signal of a pixel of the first group at that position in a frame subsequent to the second frame.

15. The camera system according to claim 12, comprising:
an image processing device that performs processing on signals read from the multiple pixels,
wherein the image processing device performs first frame reconstruction to reconstruct from information acquired of one frame, image data of that frame and second frame reconstruction to reconstruct image data of one frame from information acquired of two or more frames, and outputs one of a first reconstructing result of the first frame reconstruction, a second reconstructing result of the second frame reconstruction, and a third reconstructing result obtained by mixing the first reconstructing result and the second reconstructing result.

16. The camera system according to claim 15, wherein when obtaining the third reconstructing result, the image processing device adjusts the proportion of the first reconstructing result to be mixed and the proportion of the second reconstructing result to be mixed according to the result of estimating the degree of movement of the subject.
